(19) United States
(12) Patent Application Publication
(10) Pub. No.: US 2025/0141196 A1
(43) Pub. Date: May 1, 2025

(54) JAW ENGAGEMENT ASSIST SYSTEM

(71) Applicant: The Charles Machine Works, Inc., Perry, OK (US)

(72) Inventors: Walter George Thompson, Janesville, WI (US); Mark D. Randa, Oconomowoc, WI (US); James B. Doyle, JR., Delafield, WI (US); Robert F. Crane, Nekoosa, WI (US); Steven W. Wentworth, Scottsdale, AZ (US)

(21) Appl. No.: 18/924,316

(22) Filed: Oct. 23, 2024

Related U.S. Application Data
(60) Provisional application No. 63/593,034, filed on Oct. 25, 2023.
(60) Provisional application No. 63/552,248, filed on Feb. 12, 2024.

(51) Int. Cl. H02G 1/08

(52) U.S. Cl. CPC H02G 1/08

(57) ABSTRACT

A cable gripping assembly. The gripping assembly has two jaw assemblies for gripping and pulling a cable. Each jaw assembly has a jaw block with a tapered cavity, and a jaw subassembly which fits within the tapered cavity to grip a cable when frictional forces, caused by a hydraulic cylinder or other actuator, force the jaws into the tapered cavity. The jaw subassembly has a guide plate, which carries pins affixed to the jaws. The guide plate is ordinarily allowed to move the pins along angled slots in a jaw plate. However, when actuated by a plunger, the guide plate and pins are forced to a widest point of the angled slots, maintaining the jaws in an open position, allowing for easy removal of the strand from the gripping assembly.

### SUMMARY

The present invention is directed to a gripping assembly. The gripping assembly comprises one or more tapered jaws, a block having a tapered cavity, a jaw mounting plate subassembly with a sliding guide plate. The tapered jaw has one tapered surface. The tapered cavity comprises at least one tapered surface complementary to the tapered surface of the tapered jaw. The mounting plate subassembly contains a spring, a spring piston and a sliding guide plate wherein the spring piston and the guide plate are linked via a pin to maintain relative motion thereby passing spring forces to the guide plate. The spring and spring piston are disposed within a mounting plate boss adjacent to the guide plate. A jaw mounted pin passes through guide grooves in the jaw plate and further passes through guide slots in the sliding guide plate. The guide plate slots are configured to maintain a generally level relative position of the jaws within the jaw block taper while the guide grooves in the mounting plate generally follow the tapered surfaces of the jaw block. The tapered jaw(s) are situated within the tapered cavity when following the grooves of the mounting plate through most of the range of jaw travel with the exception of extreme upper range when the jaws go wide when lifted from the taper to facilitate installation or removal from the cable.

In another aspect, the invention is directed to a gripping assembly. The gripping assembly comprises a jaw block, a mounting plate subassembly with a jaw guide plate. The jaw block defines a tapered cavity, wherein the tapered cavity defines first and second opposed surfaces. The mounting plate subassembly comprises a plate, a first tapered jaw, and a second tapered jaw, a jaw plate and a first and second mounting pin.

The mounting plate subassembly is slidingly receivable in the jaw block and defines first and second slots. The first tapered jaw is secured to the plate by a first pin, wherein the first pin is disposed through the first slot. The first tapered jaw defines a first crush face and a first tapered jaw surface. The second tapered jaw is secured to the plate by a second pin, wherein the second pin is disposed through the second slot. The second tapered jaw defines a second crush face and a second tapered jaw surface. The first tapered jaw and second tapered jaw are situated within the tapered cavity such that the first crush surface and second crush surface are opposed, the first tapered jaw surface is adjacent and complementary to the opposed tapered surface of the tapered cavity, and the second tapered jaw surface is adjacent and complementary to the second opposed tapered surface of the tapered cavity.

The sliding guide plate is disposed adjacent to the mounting plate of the mounting plate subassembly. The guide plate engages the jaws through pins such that their tapered jaw surfaces are biased toward the respective opposed tapered surfaces of the tapered cavity.

### BRIEF DESCRIPTION OF THE DRAWINGS

FIG. 1 is a rear isometric view of a cable pulling device. A jaw block assembly and jaw plate subassembly are shown at the top of the image, with a wire cable within. A jaw set configured to hold the cable stationary between pulling cycles is disposed between the actuators of the pulling device.

FIG. 2 is a top rear view of a moving jaw assembly with a wire cable disposed between the jaws. A subassembly to carry the jaws is disposed within a moving jaw block. The subassembly is in a first position, where the jaws are allowed to open and close about the wire cable strand.

FIG. 3 is a top front view of the jaw plate subassembly for use with the system of FIG. 1, in the first position. Jaws are shown mounted on pins through a pair of slots in the jaw plate. Pins securing the jaws within those slots are out of view on the back side of FIG. 3.

FIG. 4A is a top rear view of the jaw plate subassembly, in the second position. The jaws are positioned to receive or remove a cable, however the cable is positioned between the jaws ready to be gripped.

FIG. 4B is the jaw plate subassembly of FIG. 4A, in the first position, with the jaws gripping the wire cable strand.

FIG. 5 is a top rear view of the jaw block assembly with the jaw plate subassembly removed.

FIG. 6 is a top rear view of the jaw block assembly with the jaws disengaged from the cable and the cable outside of the gripping position. The subassembly is in the second position, with the jaws locked open.

FIG. 7A is a rear plan view of the jaw plate subassembly with section line A-A. The subassembly is in the second position, with the jaws locked open.

FIG. 7B is a cutaway view of the jaw plate subassembly with the boss removed, such that the guide plate and jaw plate, as well as the pins disposed therethrough and into the jaws, may be seen. In FIG. 7B, the subassembly is in the first position.

FIG. 8 is a left sectional view of section A-A from FIG. 7A.

FIG. 9 is a left rear view of an alternative boss for use with a jaw block subassembly, in the first position.

FIG. 10 is a top left rear view of the boss of FIG. 9, with the strand removed, the jaws open, and the assembly in the second position.

### DETAILED DESCRIPTION

Wire rope or rod gripping systems are used for replacement of underground utilities. A wire rope or rod is typically used to pull tooling through an existing pipe that will crack, split, slit or remove the pipe where it is buried while towing an expander to open the adjacent soil and permit the new product to be pulled along into the bore after the tooling passes.

In many gripping systems, a tapered jaw or jaws are designed to slide in a matching tapered jaw block. As the force between the jaw face contacting the cable increases, the jaws are forced deeper into the jaw block taper thereby increasing the squeezing force on the wire rope and therefore the friction to hold it in position relative to the jaw block.

The challenge of the process is often initiating the force between the tapered jaw and the pulling wire rope or strand. A modest amount of externally applied force will initiate the gripping; that modest force then grows as the jaw block is moved to pull the strand and the jaws will wedge with this pulling movement.

While the primary job of the jaws is to grip the strand, at the start and end of the job, the strand must be placed between the jaws or—in the case of a single jaw arrangement—between one jaw and a friction face. As shown in the Figures, the jaws have an arcuate profile crushing face to surround the circular profile of the cable. In order to position the jaws as required, jaws often need to be removed from the jaw block or they must slide a meaningful distance toward the open end of the tapered faces in the jaw block.

An ideal device is one that is easily brought into position to bear upon the jaw(s) once the pulling strand is installed and equally easily moved out of the way when the job is done to allow the jaws to slide a meaningful distance, enabling easy removal of the jaws from the vicinity of the strand.

Turning now to the Figures in general, shown therein is a strand pulling apparatus 10 for gripping a strand 15. The apparatus has a stationary jaw block 14 and a moving jaw block 13. One or more actuators, here hydraulic cylinders 17, provide the relative motion between the stationary block 14 and the moving jaw block 13. The stationary jaw block 14 is attached to barrels 23, while the moving jaw block 13 is attached to rods 24 of the hydraulic cylinders 17. As shown, the actuators are hydraulic cylinders, though other actuators, such as electrically actuated devices, may be used.

The moving jaw block 13 is configured to grip the strand 15 as it is pulled away from the stationary jaw block 14. When the moving jaw block 13 is at full extension, the cylinders 17 may retract for another stroke. During this action, the strand 15 will tend to rebound. However, the stationary jaw block 14 prevents such rebounding, “holding” the strand 15 in place until the moving jaw block 13 is fully retracted for a subsequent stroke. Restraining rebound causes each stroke of the cylinders 17 and the movable jaw block 13 to be more productive.

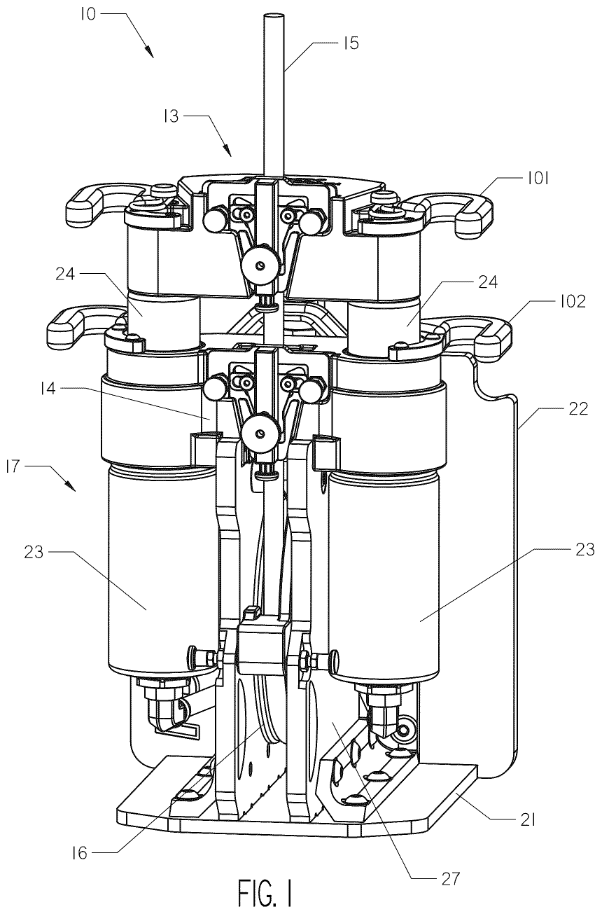

With reference to FIG. 1, the apparatus 10 is supported on a base 21. The base 21 is ordinarily on the floor of a pit, while a reaction face 22 is flush against a wall of the pit. Forces due to the extension of the cylinders 17 are transmitted to the face 22 and base 21 through plates 27. This allows the forces, provided by cylinders 17, to be opposed by the earth as the strand 15 is pulled through the subsurface. Most of the forces will be against face 22, due to the routing of the strand 15 around a sheave 16. Such apparatus 10 may, for example, apply a maximum tensile force of 29 tons on a ¾″ diameter flexible wire strand 15. The strand 15 may be disposed in the subsurface within an existing pipe, and include an expanding or bursting tool (not shown) at its distal end.

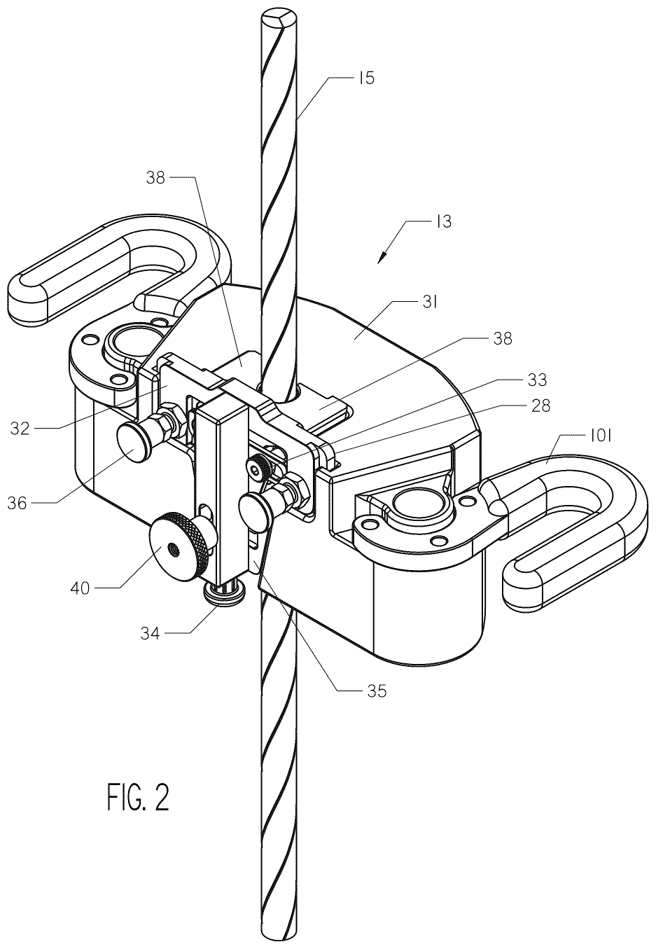

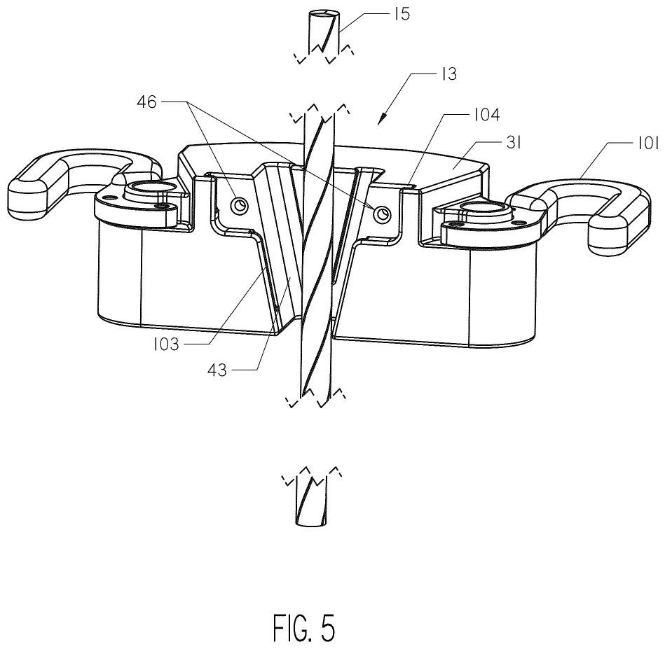

With reference to FIG. 2, the moving jaw block 13 is shown in more detail. Details of the moving jaw block 13 are similar or identical in the stationary jaw block 14. The moving jaw block comprises a jaw mounting plate subassembly 28 and a block structure 31. The subassembly 28 is carried in a pocket of the block structure 31. The subassembly is attached to jaws 38, which are shown, in FIG. 2, within the tapered pocket 43 (FIG. 5) of the block structure 31. A handle 101 is provided on the block structure 31 of the moving jaw block 13. Handle 101 provides a convenient way to manually assist the assembly of moving jaw block 13 relative to the-rest of apparatus 10. Similarly, handle 102 provides a way to adjust the stationary jaw block 14.

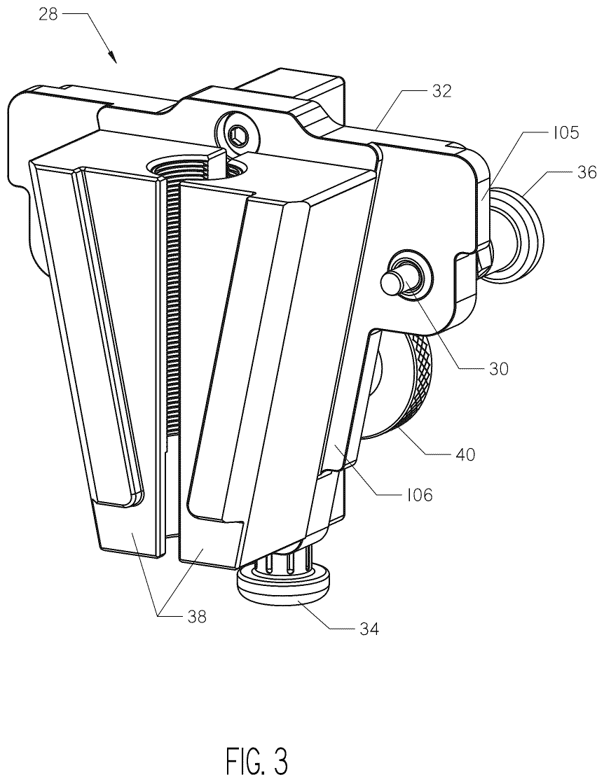

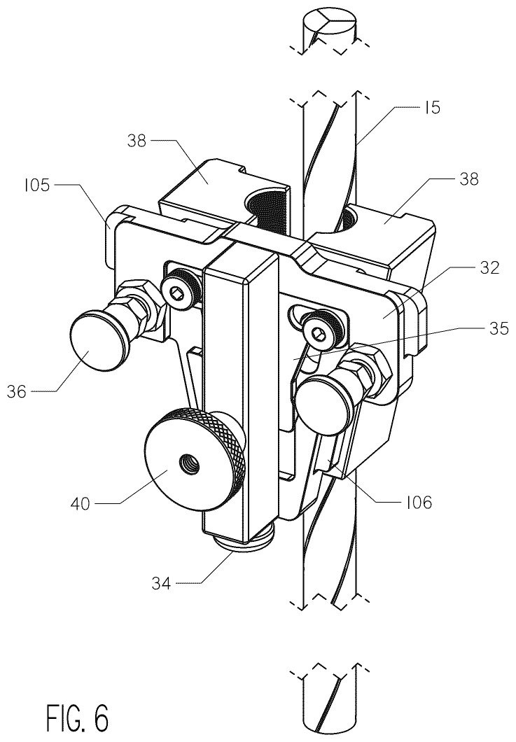

With reference now to FIGS. 3-6, the jaw block structure 31 and mounting plate subassembly 28 are shown in a disassembled state. The jaw block structure 31 includes the tapered pocket 43. The pocket has tapered walls 44 which cooperate with complementary tapered walls of the jaws 38 to provide a clamping force on the jaws 38 when the strand 15 is being pulled. Each jaw 38 has a crush face disposed opposite the tapered wall, which is shown as being arcuate, to grip a strand 15 disposed between the crush faces.

The pocket 43 has mating features 103 and 104. Mating features 103, 104 engage with tabs 105, 106 disposed on the mounting plate subassembly 28 to locate the mounting plate subassembly 28 in place.

Further, the pocket 43 has two holes 46 (FIG. 5), which are located to mate with pins 30 (FIG. 3). The pins 30 are preferably spring loaded, and may be removed by pulling on plungers 36. Slotting the pins 30 into holes 46 provides additional security between the subassembly 28 and the jaw block structure 31.

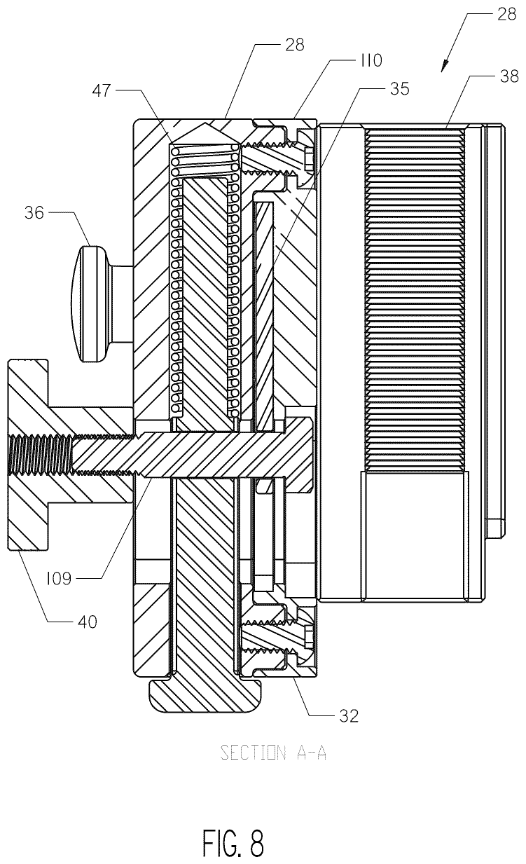

The mounting plate subassembly 28 comprises a jaw plate 32, pins 33, a guide plate 35 and a guide plate plunger 34. The guide plate 35 is movable relative to the jaw plate 32 as limited by a bolt 109, which is fixed in position relative to the guide plate 35 and disposed within an opening in the jaw plate 32. The guide plate plunger 34, as best seen in FIG. 8, is disposed within a boss 110, and manipulates the position of the bolt 109.

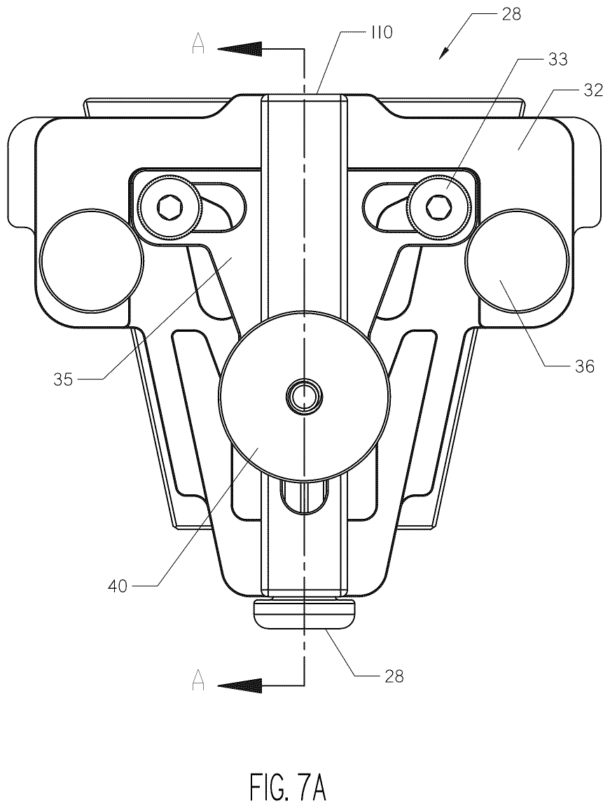

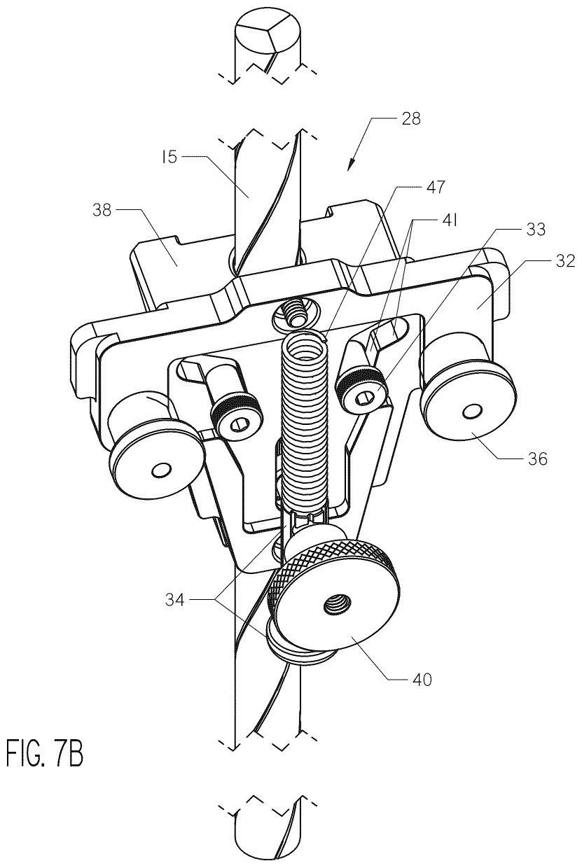

The guide plate plunger 34 is biased into a first position, shown in FIGS. 2, 3, 4B, 7B and 9 by a compression spring 47. In the first position, a clamp knob 40 and an associated bolt 109 are allowed to travel within a slot or opening 120 formed in the boss 110 and jaw plate 32. This travel allows the jaws 38 to alternatively clamp and release the strand 15.

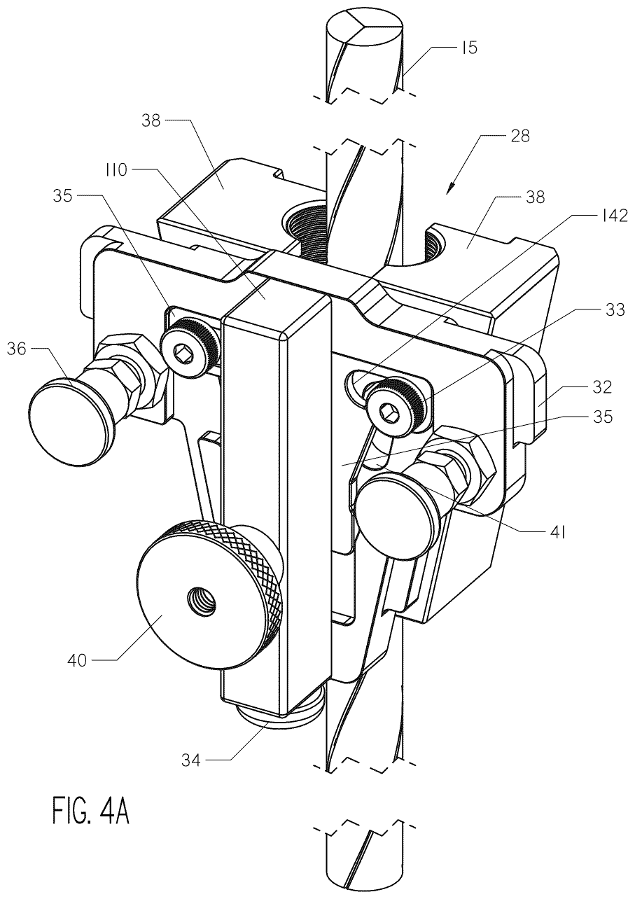

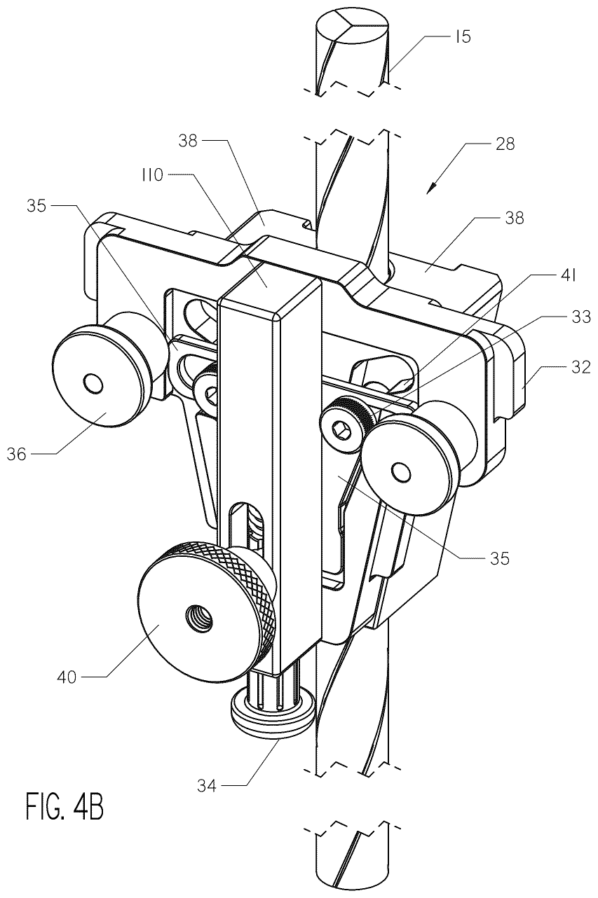

In the second position, shown in FIGS. 4A, 6, 7A and 10, the guide plate plunger 34 is depressed, forcing the guide plate 35 up relative to the jaw plate 32, thus forcing the jaws to remain open. Preferably, the plunger 34 may be depressed by finger pressure. Optionally, the clamp knob 40 may be tightened down on the outside of the boss 110 outside of the opening 120, overcoming the bias of the spring 47 in a second position. In the second position, the jaws 38 are not allowed to descend into the tapered pocket 43 of the block 31.

As shown, the guide plate 35 motivates the two jaws 38 to move relative to the jaw plate 32. The guide plate 35 has horizontal slots 142 within which the pins 33 are placed. The pins 33 are also disposed through angled slots 41. The jaws 38 slide on and react to wedging forces through tapered sliding surfaces 44. The angled slots 41 are similarly angled as tapered sliding surfaces 44 to provide free travel of jaws 38 along their mating sliding surface 44. In the embodiment shown, angled slots 41 are not contacted by pins 33 during operation, but rather are large enough to allow relative movement of the pins 41 as dictated by the sliding surfaces 44.

As shown, the pins 33 comprise a shoulder bolt, attached to a corresponding jaw 38. It should be understood that the pins 33 may have any form capable of extending through the guide plate 35 and affixed to the jaws 38. For example, the pins 33 could be integrally-formed protrusions extending from each jaw 38.

The guide plate plunger 34 is disposed through the boss 110, and can be translated with thumb pressure to compress the spring 47. This action raises the guide plate 35 and forces the pins “up” the angled slots 41. Thus, due to the angle of sliding surfaces 44, the jaws 38 move away from the strand 15 to allow installation or removal of the mounting plate subassembly 28 from the jaw block. With the subassembly 28 and therefore the jaws 38 removed, the strand 15 can easily be moved away from the apparatus 10, and the jaws 38 can be repaired or replaced.

When the clamp knob 40 is backed out of the opening 120 formed in the boss 110, the bolt 109 is fixed in place relative to the jaw block structure 31. This arrangement locks the jaws 38 in the open position, as shown in FIG. 8. Alternatively, the clamp knob 40 may be tightened when within the opening, allowing travel within the opening 120 and ordinary operation of the assembly 10.

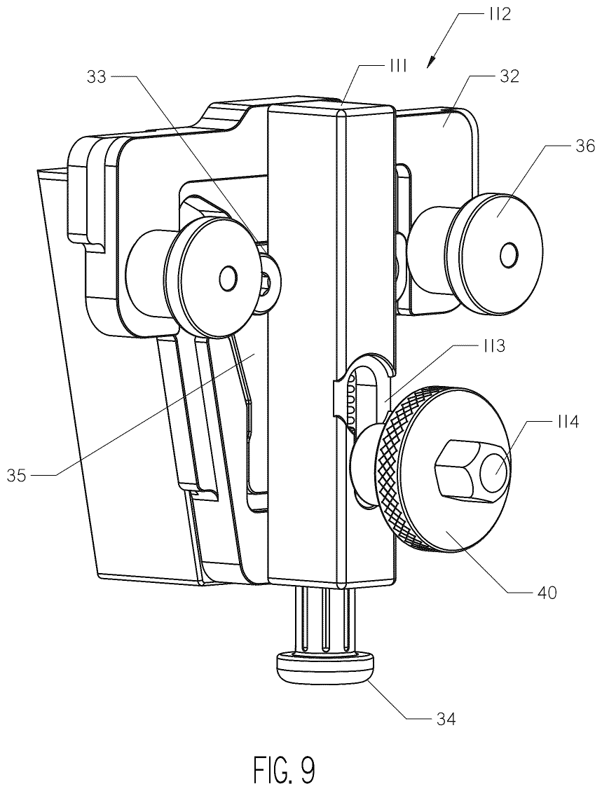

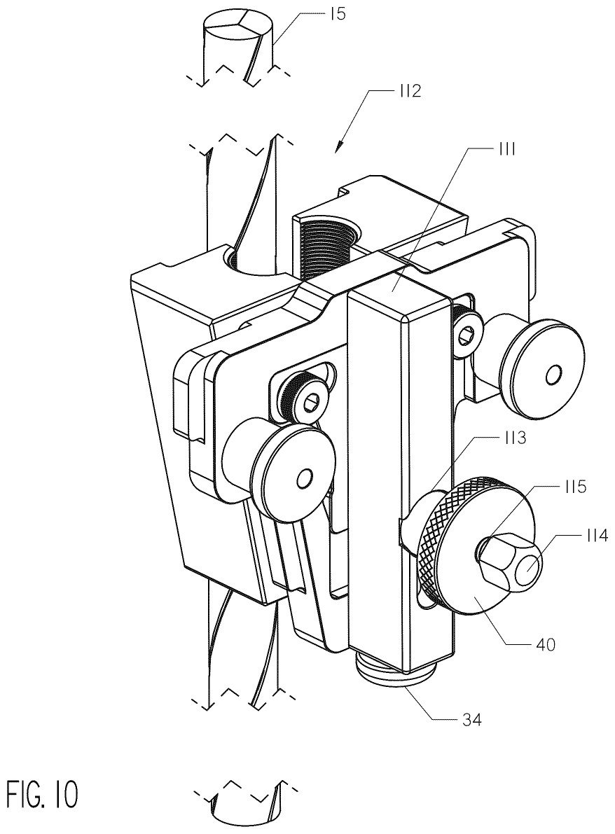

In FIGS. 9 and 10, a different embodiment of the knob 40 is shown. FIG. 9 is a mounting plate subassembly 112 which is a slightly modified version of mounting plate assembly 28 in that bolt 109 is longer than the bolt shown in FIG. 8, and it extends beyond the outer face of knob 40. Additionally, a nut (for example, an acorn nut) 114 is disposed on the threaded end of lengthened bolt 109. In FIG. 9, the jaws 38 are free to move up and down along the angled slots 41 (FIGS. 4A-4B) with the jaws 38 shown in the clamped position.

With the jaws 38 in the clamped position the knob 40 is low on boss 111 which exposes counterbore 113. Counterbore 113 is the only feature of boss 111 that differs from boss 110. In FIG. 9, the knob 40 is threaded out on bolt 109 such that it is jammed against nut 114 thereby locking the knob 40 into position and ensuring that the entire mechanism associated with jaws 38 is free to travel vertically. This free movement is required during normal pulling operation, as with the subassembly 28 of FIGS. 3-8.

In FIG. 10, mounting plate assembly 112 is in an open and locked position. The open position of the jaws 38 facilitates installation and removal of the mounting plate assembly 112 around or from strand 15. In this configuration the knob 40 is buried into counterbore 113 thereby producing gap 115 on lengthened bolt 109 thereby preventing any vertical travel. This eliminates any need to hold the button end on guide plate plunger 34 in a depressed condition, compressing spring 47 to keep the jaws 38 open. By simply backing knob 40 out of counterbore 113, the jaws are set free to travel under the force applied by spring 47.

Therefore, whether subassembly 28 or 112 is used, the ease of removing jaws 38 from around the strand 15 is the same. Operation may be shown in FIGS. 4A and 4B. In FIG. 4A, the knob 40 is in the first position, and the guide plate plunger 34 is extended. In this orientation, the guide plate 35 is allowed to travel relative to the jaw plate 32. Thus, the pins 33 and jaws 38 may move relative to slots 41, as constrained by the tapered surfaces 44 of the jaw block structure 31. As a result, as shown in FIG. 4B, the jaws 38 are clamping the strand 15. The slots 41, though not contacted by pins 33 while in operation, allow the pins 33 to maintain the jaws 38, jaw plate 32, and guide plate 35 as a subassembly when removed.

In FIG. 4A, the jaws 38 are in the process of being either disassembled or assembled with respect to the jaw plate subassembly 28. Therefore, the guide plate plunger 34 has been depressed (with the knob 40 optionally tightened to prevent travel of the guide plate 35 and jaws 38), and plungers 36 have been retracted to remove pins 30 (FIG. 3) from holes 46 (FIG. 5). This frees the subassembly 28 from holes 46 in the jaw block structure 31. The subassembly 28 may then be lifted upward and out of the jaw block structure 31.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed. For example, there need only be one jaw 38 if a stationary reaction surface is used. Likewise, in a multiple jaw 38 system, only one jaw needs to be loaded, though both may be, as shown.

1. A jaw assembly, comprising:
a jaw block having a tapered jaw pocket formed therein;
a pair of opposed jaws disposed in the jaw pocket;
a pair of pins, each of the pair of pins attached to one of the corresponding pair of opposed jaws;
a first jaw plate having a pair of angled slots, wherein each of the pair of pins is disposed within a distinct one of the pair of angled slots; and
a guide plate, movable relative to the first jaw plate, the guide plate having a pair of horizontal slots, wherein each of the pair of pins is disposed within a distinct one of the pair of horizontal slots;
a plunger, wherein a position of the plunger determines a position of the first jaw plate relative to the guide plate, wherein the pair of pins are moved away from each other along the angled slots when the plunger is in a depressed position.

2. The jaw assembly of claim 1 in which the plunger is spring-biased away from the depressed position.

3. The jaw assembly of claim 2 further comprising a frictional override, configured to selectively maintain the plunger in the depressed position.

4. The jaw assembly of claim 3 wherein the frictional override comprises a knob.

5. The jaw assembly of claim 1 further comprising a bolt, wherein the bolt is disposed through the plunger and the guide plate, and wherein the bolt is guided along a vertical path by the first jaw plate.

6. The jaw assembly of claim 1 wherein the jaw block is characterized by a mating hole, wherein the first jaw plate further comprises a mating pin, wherein the mating pin is selectively insertable in the mating hole of the jaw block.

7. The jaw assembly of claim 5 wherein the mating pin is attached to a spring-loaded mating plunger, wherein the mating plunger biases the pin to an extended position.

8. A cable gripping device comprising:
a frame;
an actuator supported on the frame, the actuator having a stationary end attached to the frame and a movable end;
the jaw assembly of claim 1, mounted on the movable end of the frame.

9. The cable gripping device of claim 8, wherein the jaw assembly is characterized as a moving jaw assembly, and further comprising:
a stationary jaw assembly, attached to the frame, the stationary jaw assembly comprising:
a second jaw block having a second tapered jaw pocket formed therein;
a second pair of opposed jaws disposed in the second tapered jaw pocket;
a second pair of pins, each of the second pair of pins attached to one of the corresponding second pair of opposed jaws;
a second jaw plate having a second pair of angled slots, wherein each of the second pair of pins is disposed within a distinct one of the second pair of angled slots; and
a second guide plate, movable relative to the second jaw plate, the second guide plate having a second pair of horizontal slots, wherein each of the second pair of pins is disposed within a distinct one of the second pair of horizontal slots; and
a second plunger, wherein a position of the second plunger determines a position of the second jaw plate relative to the second guide plate, wherein the second pair of pins are moved away from each other by the second angled slots when the second plunger is in a depressed position.

10. The cable gripping device of claim 9 wherein a strand is disposed between the pair of opposed jaws and the second pair of opposed jaws.

11. The cable gripping device of claim 1 wherein each of the pair of pins comprises a shoulder bolt.

12. The cable gripping device of claim 1 wherein each of the pair of pins are integral with the one of the corresponding pair of opposed jaws.

13. A gripping apparatus for pulling a strand, comprising:
a jaw block having a tapered cavity;
at least one jaw disposed within the tapered cavity, the jaw configured to grip the strand and comprising a protrusion;
a plate having a horizontal slot in which the protrusion of the at least one jaw is constrained; and
a plunger, configured to manipulate a position of the at least one jaw relative to the tapered cavity of the jaw block.

14. The gripping apparatus of claim 13, further comprising a bolt, wherein the bolt is secured through the plate, and a position of the bolt relative to the jaw block is configured to be controlled by the plunger.

15. The gripping apparatus of claim 14 in which the plunger is spring-biased to a first position, wherein the bolt is movable relative to the first plate in the first position.

16. The gripping apparatus of claim 15 further comprising a frictional override, wherein the frictional override is configured to hold the plunger in a second position, wherein the protrusion of the at least one jaw is maintained in a position where the at least one jaw does not grip a strand when the plunger is in the second position.

17. The gripping apparatus of claim 13 wherein the protrusion comprises a pin.

18. The gripping apparatus of claim 13 wherein the plate is characterized as a second plate and further comprising a first plate, wherein the first plate has an angled slot, wherein the protrusion of the at least one jaw is disposed through the angled slot.

19. A method of removing a jaw subassembly from a gripping apparatus, the gripping apparatus comprising a pair of opposed jaws attached to a jaw plate, the method, comprising:
with the pair of opposed jaws disposed in a tapered cavity within a jaw block, gripping and pulling a strand in a first direction;
depressing a plunger to move each of the pair of opposed jaws along an angled path defined by an angled slot in the jaw plate; and
thereafter, removing the jaw plate and jaws from the jaw block.

20. The method of claim 19, further comprising removing a pair of mating pins from a corresponding pair of mating depressions in the jaw block prior to removing the jaw plate from the jaw block.

21. The method of claim 19, further comprising the step of engaging a frictional override to hold the plunger in place after the step of depressing the plunger.

22. The method of claim 19 in which the frictional override is a knob disposed within a counterbore.

23. The method of claim 19 in which the step of depressing the plunger moves a guide plate, wherein the jaws are fixed relative to the guide plate and slidable relative to the jaw plate.

24. The method of claim 23 in which upon the step of removing the jaw plate and jaws from the jaw block, the guide plate, jaw plate, and jaws are retained as a unit by at least one pin disposed through the guide plate, jaw plate, and jaws.
